(19) United States
(12) Patent Application Publication
(10) Pub. No.: US 2018/0023466 A1
(43) Pub. Date: Jan. 25, 2018

(54) FUEL REFORMER FOR USE WITH AN INTERNAL COMBUSTION ENGINE

(71) Applicant: Caterpillar Inc., Peoria, IL (US)

(72) Inventor: Charlie C. Kim, Dunlap, IL (US)

(73) Assignee: Caterpillar Inc., Peoria, IL (US)

(21) Appl. No.: 15/217,186

(22) Filed: Jul. 22, 2016

(51) Int. Cl. F02B 43/08; F02M 31/08; F02M 25/12

(52) U.S. Cl. CPC F02B 43/08; F02M 25/12; F02M 31/08

(57) ABSTRACT

A method for reforming fuel for an engine is disclosed. The method comprising heating, in a non-catalytic combustor, a mixture of fuel and air at a temperature in a range from 550K to 950K, to partially oxidize the fuel to generate one or more free radicals. The one or more free radicals constitute reformed fuel. Further, the reformed fuel is supplied to the engine.

### TECHNICAL FIELD

The present disclosure relates to an internal combustion engine. More specifically, the present disclosure relates to a fuel reformer for use with the internal combustion engine.

### BACKGROUND

In a typical internal combustion engine (hereinafter referred to as the engine), a mixture of fuel and air is ignited to generate exhaust gases, which are usually discharged into the atmosphere. The exhaust gases may include oxides of nitrogen (“NOₓ”) and it may be required to reduce NOₓ emissions. To reduce NOₓ emissions, a portion of the exhaust gases is recirculated into the engine along with the mixture of the fuel and the air. However, if the amount of the exhaust gases that is recirculated is increased beyond a certain limit, ignition of the air fuel mixture becomes challenging due to the high concentration of residuals. This may lead to improper combustion of the fuel. Improper combustion of the fuel may correspond to engine misfiring or improper flame propagation during combustion of the fuel.

Using leaner fuel mixtures in the engine may also lead to improper combustion of the fuel. Leaner fuel mixtures correspond to increased air to fuel ratio, which is supplied to the engine to improve efficiency when accompanied by Miller cycle and highly efficient air systems. However, if the air to fuel ratio is increased beyond a certain limit, achieving stable, robust ignition may be challenging due to increased air dilution.

One way to achieve proper combustion (during increased exhaust gas recirculation or when using high air to fuel ratio) may include reforming the fuel before it is supplied to the engine.

WO application 2011151560 ('560) discloses a fuel reformer that reforms the fuel to generate hydrogen rich gas. The fuel reformer includes a catalyst, which is heated at high temperatures to facilitate fuel reformation. This reformation of the fuel using the catalyst may have an additional cost overhead.

### SUMMARY

Various aspects of the present disclosure disclose a method for reforming fuel for an engine. The method comprising heating, in a non-catalytic combustor, a mixture of fuel and air at a temperature in a range from 550K to 950K, to partially oxidize the fuel to generate one or more free radicals. The one or more free radicals constitute reformed fuel. Further, the reformed fuel is supplied to the engine.

Various aspects of the present disclosure disclose an engine system. The engine system comprises an engine. The engine system further comprises a fuel reformer fluidly coupled to the engine to supply reformed fuel to the engine. The fuel reformer includes a first combustor portion configured to receive a mixture of fuel and air. The first combustor portion heats the mixture of the fuel and the air at a first temperature for a first predetermined time period to partially oxidize the fuel to generate one or more first free radicals. The first temperature lies in a range from 550K to 750K. The fuel reformer further includes a second combustor portion configured to receive the one or more first free radicals, and the mixture of fuel and the air. The second chamber heats the mixture of the fuel and the air, and the one or more first free radicals at a second temperature for a second predetermined time period to transform the one or more first free radicals to one or more second radicals. The one or more second radicals constitute the reformed fuel to be supplied to the engine. The second temperature lies in a range from 750K to 950K. The first combustor portion and the second combustor portion correspond to a non-catalytic combustor.

### BRIEF DESCRIPTION OF THE DRAWINGS

FIG. 1 illustrates a diagrammatic illustration of an engine system, in accordance with the concepts of the present disclosure;

FIG. 2 illustrates a schematic of a fuel reformer, in accordance with the concepts of the present disclosure; and

FIG. 3 illustrates a flowchart of a method for reforming fuel, in accordance with the concepts of the present disclosure.

### DETAILED DESCRIPTION

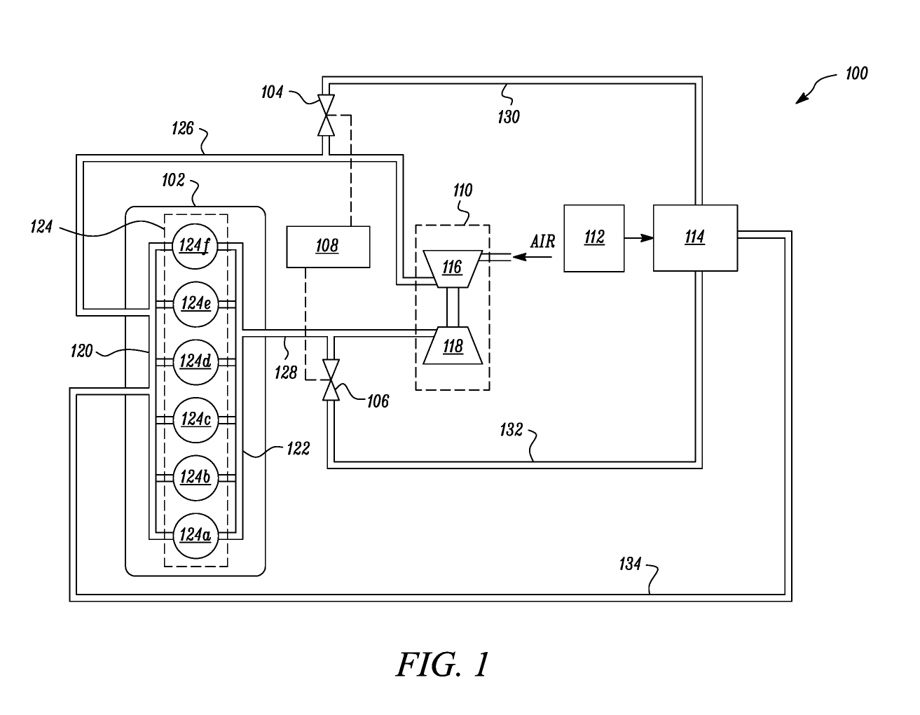

Referring to FIG. 1 an engine system 100 is illustrated. The engine system 100 includes an engine 102, a first valve 104, a second valve 106, a controller 108, a turbocharger 110, a fuel tank 112, and a fuel reformer 114. In an embodiment, the turbocharger 110 further includes a compressor 116 and a turbine 118.

In an embodiment, the engine 102 includes an intake manifold 120 that is fluidly coupled to the compressor 116 through a first intake conduit 126. The intake manifold 120 is further coupled to the fuel reformer 114 through a second intake conduit 134. The engine 102 further includes one or more cylinders 124 such as the cylinders 124a-124f (as illustrated in FIG. 1). The one or more cylinders 124 are coupled to the intake manifold 120 and an exhaust manifold 122. The exhaust manifold 122 is coupled to the turbine 118 through a first exhaust conduit 128. Further, the exhaust manifold 122 is coupled to the fuel reformer 114 through a second exhaust conduit 132. In an embodiment, the second exhaust conduit 132 is coupled to first exhaust conduit 128 upstream of the turbine 118. In an alternate embodiment, the second exhaust conduit 132 is coupled to an outlet of the turbine 118 downstream of the turbine 118. The engine 102 may be based on one of the commonly applied power-generation units, such as an internal combustion engine (ICE). The engine 102 may include a V-type engine, in-line engine, or an engine with different configurations, as is conventionally known. Although not limited, the engine 102 may be a spark-ignition engine or a compression ignition engine, which may be applied in construction machines or locomotives. However, aspects of the present disclosure, need not be limited to a particular engine type.

In operation, the fuel reformer 114 receives fuel from the fuel tank 112. The fuel reformer 114 reforms the fuel and supplies the reformed fuel to the intake manifold 120 of the engine 102 through the second intake conduit 134. However, those skilled in the art would appreciate that the scope of the disclosure is not limited to supplying the reformed fuel to the engine 102 through the intake manifold 120. In an embodiment, the reformed fuel may be supplied to engine 102 through a compressor inlet (not shown), individual ports in the cylinder of the engine 102, directly into the cylinder of the engine 102, or into a prechamber coupled to the engine 102, without departing from the scope of the disclosure. The intake manifold 120 further receives the compressed air from the compressor 116 through the first intake conduit 126. The reformed fuel mixes with the compressed air in the intake manifold 120 to form air-fuel mixture. The air-fuel mixture is provided to the one or more cylinders 124. In an embodiment, during engine operation, the reformed fuel is ignited to produce energy, which is utilized to perform predetermined tasks. In the process of generation of the energy, exhaust gases are generated. The exhaust manifold 122 receives the exhaust gases from the one or more cylinders 124. The exhaust gases are provided to the turbine 118 through the first exhaust conduit 128. From the turbine 118, the exhaust gases are provided to the fuel reformer 114 through the second exhaust conduit 132. In an alternate embodiment, the exhaust gases may supplied to the fuel reformer 114 directly from the exhaust manifold 122. In such a scenario, the second exhaust conduit 132 is coupled to the exhaust manifold 122 of the engine 102 and the fuel reformer 114 to supply the exhaust gases from the engine 102 to the fuel reformer 114. The turbine 118 receives the exhaust gases from the engine 102. The exhaust gases cause the turbine 118 to rotate, which in turn operates the compressor 116. The compressor 116 receives and compresses the air from the environment and provides the compressed air to the engine 102 through the first intake conduit 126. Further, a portion of the compressed gases is provided to the fuel reformer 114 through a third conduit 130. Hereinafter, the compressed air has been replaceably referred to as air for sake of brevity.

A person having ordinary skills in the art would appreciate that the scope of the disclosure is not limited to having the turbine 118 to operate the compressor 116. In an embodiment, the compressor 116 may be directly operated by the engine 102. In such a scenario, the turbine 118 may not be required. To this end, the exhaust gases from the engine 102 may be directly supplied to the fuel reformer 114 through the second exhaust conduit 132.

In an embodiment, the third conduit 130 and the second exhaust conduit 132 may include the first valve 104 and the second valve 106, respectively. The first valve 104 and the second valve 106 are used to control the flow of the compressed air and the exhaust gases into the fuel reformer 114. The first valve 104 and the second valve 106 may be actuated electrically, pneumatically, hydraulically, or any other known methodology without departing from the scope of the disclosure. In an embodiment, the controller 108, communicatively coupled to the first valve 104 and the second valve 106, is configured to actuate of the first valve 104 and the second valve 106. Therefore, the controller 108 is configured to control the flow of the compressed air and the exhaust gases into the fuel reformer 114 by controlling the actuation of the first valve 104 and the second valve 106, respectively. In an embodiment, the controller 108 may correspond to an Engine Control Unit (ECU). In an embodiment, the functionalities of the controller 108 may be implemented on an application server (not shown) installed at a remote location. The controller 108 includes a processor, a memory device, and a transceiver.

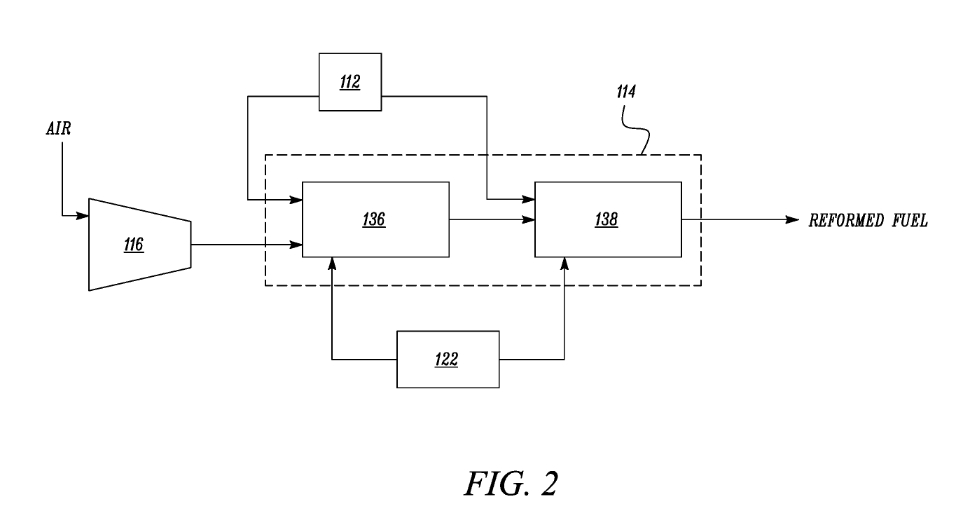

Referring to FIG. 1 and FIG. 2, the fuel reformer 114 corresponds to a non-catalytic combustor that receives the compressed air from the compressor 116 through the third conduit 130, the exhaust gases from the engine 102 through the second exhaust conduit 132, and fuel from the fuel tank 112. In the fuel reformer 114, the fuel mixes with the air to form a mixture of the fuel and the air. In an embodiment, the fuel may correspond to a liquid fuel or a gaseous fuel. Some examples of the fuel may include, but not limited to, diesel, gasoline, methane, hydrogen, and compressed natural gas (CNG). For the purpose of ongoing description, the fuel has been considered as methane, however, the scope of the disclosure is not limited to the fuel as methane. In an embodiment, the disclosed embodiments are applicable on any other types of the fuel.

In an embodiment, the exhaust gases received by the fuel reformer 114 is mixed with the mixture of the fuel and the compressed air. As the exhaust gases carry the heat (generated due to combustion of the fuel) from the engine 102, the exhaust gases are utilized to heat the mixture of the fuel and the air at a predetermined temperature in a range from 550K to 950K. In an embodiment, heating the mixture of the fuel and the air at the predetermined temperature, partially oxidizes the fuel to generate one or more free radicals. The one or more free radicals correspond to the reformed fuel, which is supplied to the engine 102 for combustion purpose. In an embodiment, the fuel reformer 114 partially oxidizes the fuel in absence of a catalyst. Therefore, the fuel reformer 114 corresponds to a non-catalytic combustor.

As the exhaust gases are mixed with the fuel and compressed air, the mixture of the compressed air and fuel and the may not ignite at temperatures (such as 950K). Therefore, this enables the breakdown or partial oxidation of the fuel at the temperatures (such as 950K) without actual ignition of the fuel. In an alternate embodiment, the exhaust gases are not mixed with the mixture of the fuel and the compressed air. In such a scenario, the exhaust gases are utilized to heat the mixture of the fuel and the compressed air through a heat exchanger.

A person having ordinary skills in the art would appreciate that the scope of the disclosure is not limited to heating the mixture of the fuel and the air using the heat from the exhaust gases. In an embodiment, any other heat source may be utilized to heat the mixture the fuel and the air. For example, the heat from engine 102 may be transferred to the fuel reformer 114 through a heat exchanger.

Further, to partially oxidize the fuel, the fuel is retained in the fuel reformer 114 for a predetermined time period. Therefore, the fuel is heated, in the fuel reformer 114, for the predetermined time period to generate the one or more free radicals. In an embodiment, the predetermined time period may be in a range from 0.05 second to 1.2 seconds. To ascertain that the mixture of the fuel and the air resides in the fuel reformer 114 for the predetermined time period, the flow of the compressed air and the fuel is accordingly adjusted by controlling the valves (for example the second valve 106). In an embodiment, the dimensions of the fuel reformer 114 are such that the fuel and the air are retained in the fuel reformer 114 for the predetermined time period. In yet another embodiment, the flow of the fuel and the air is adjusted according to the dimensions of the fuel reformer 114. In an alternate embodiment, the fuel reformer 114 may include an entry valve and an exit valve that facilitates the retention of the fuel in the fuel reformer 114 for the predetermined time period. In such a scenario, the opening and closing of the entry valve and the exit valve is controlled by the controller 108. The controller 108 may determine whether the predetermined time period is elapsed, and accordingly controls the opening or the closing of the entry valve and the exit valve. In yet another embodiment, the fuel reformer 114 may include an orifice that may restrict the flow of the mixture of the fuel and the compressed air in such a manner that the mixture of the fuel and the compressed air is retained in the fuel reformer 114 for the predetermined time period

In an embodiment, the fuel reformer 114 may be realized through a conduit. The fuel reformer 114 may include a first combustor portion 136 and a second combustor portion 138. The second combustor portion 138 is fluidly coupled to the first combustor portion 136. In an embodiment, the first combustor portion 136 and the second combustor portion 138 may be realized in the conduit. For example, the conduit may be virtually partitioned based on the temperature at different portions of the conduit. For example, a portion of the conduit where the temperature is in the range from 550K to 750K corresponds to the first combustor portion 136. Similarly, a portion of the conduit where the temperature is in the range from 750K to 950K corresponds to the second combustor portion 138. In an alternate embodiment, the conduit may include a partition in the conduit. The first partition may correspond to the first combustor portion 136 and the second partition may correspond to the second combustor portion 138. Further, the partition may include an orifice that fluidly couples the second combustor portion 138 with the first combustor portion 136. In yet another alternate embodiment, the first combustor portion 136 and the second combustor portion 138 may correspond to independent chambers that are coupled with each other through a conduit.

In an embodiment, the first combustor portion 136 comprises an inlet for the exhaust gases (received from the engine 102), an inlet for the fuel (received from the fuel tank 112), and an inlet for the compressed air (received from the compressor 116). Further, the first combustor portion 136 comprises an outlet fluidly coupled to the second combustor portion 138. The second combustor portion 138 comprises an inlet for the exhaust gases and an inlet for the fuel and compressed air.

In an embodiment, the first combustor portion 136 may receive the compressed air from the compressor 116, the exhaust gases from the engine 102 and the fuel from the fuel tank 112 in such a manner that the first combustor portion 136 includes a predetermined ratio of the compressed air, the exhaust gases, and the fuel. For instance, the first combustor portion 136 includes 35% of compressed air, 45% of exhaust gases, and 25% of the fuel. In an embodiment, the predetermined ratio is deterministic of a fuel-air equivalence ratio in the first combustor portion 136. For instance, the predetermined fuel-air equivalence ratio may be 6PHI.

Further, in an embodiment, the percentage of the exhaust gases in the first combustor portion 136 may be deterministic of the temperature maintained in the first combustor portion 136. For example, 45% of the exhaust gases in the first combustor portion 136 may facilitate the heating of the first combustor portion 136 to a first temperature in a range from 550K to 750K. The heating of the first combustor portion 136 facilitates the heating of the mixture of the fuel and the compressed air that in turn leads to partial oxidation of the fuel to generate one or more first free radicals. In an embodiment, the fuel is partially oxidized in absence of any catalyst. Therefore, the first combustor portion 136 corresponds to a non-catalytic combustor. In an embodiment, the following chemical reaction process is facilitated by the first combustor portion 136 to generate the one or more first free radicals:

CH₃+OH→CH₃+H₂O

CH₃+O2 [symbol] CH₃O₂

CH₃O₂+H₂O→CH₃O₂H+OH

CH₃O₂H->CH₃O+OH

In an embodiment, CH₃O₂, CH₃, CH₃O₂H, CH₃O, and OH correspond to the one or more first free radicals. A person having ordinary skill in the art would appreciate that the scope of the disclosure is not limited to the aforementioned radicals as the one or more first radicals. In an embodiment, the composition of the one or more first radicals is dependent on the predetermined ratio of the compressed air, the fuel, and the exhaust gases in the first combustor portion 136.

In an embodiment, to facilitate the generation of the one or more first free radicals, the first combustor portion 136 is so designed that the mixture of the fuel and the air resides in the first combustor portion 136 for a first predetermined time period. The first predetermined time period ensures that the mixture of the fuel and the air is heated to the first temperature for partial oxidation of the fuel. In an embodiment, the first predetermined time period may be 1 second. As discussed supra, in order to ascertain that the mixture of the fuel and the compressed air resides in the first combustor portion 136 for the first predetermined time period, the first combustor portion 136 may be designed accordingly. For example, the length of the first combustor portion 136 may be such that the mixture of the fuel and the compressed air resides in the first combustor portion 136 for the first predetermined time period. In another embodiment, partition between the first combustor portion 136 and the second combustor portion 138 may include an orifice that restricts the flow of the mixture of the fuel and the compressed air to ascertain the residing time period as the first predetermined time period. In yet another embodiment, the first combustor portion 136 may include an entry and exit valves, which may be controlled by the controller 108, to control the residing time period. After the first predetermined time period has elapsed, the one or more first free radicals are provided to the second combustor portion 138.

A person having ordinary skills in the art would appreciated that complete fuel is not partially oxidized. Some quantity of the fuel and the air is passed to the second combustor portion 138 along with the one or more first free radicals.

The second combustor portion 138 receives the one or more first free radicals, and the mixture of the fuel and the air, from the first combustor portion 136. Further, the second combustor portion 138 receives the exhaust gases from the engine 102 and the fuel the fuel tank 112, respectively. Further, in an embodiment, the exhaust gases and the fuel are supplied to the second combustor portion 138 in such a manner that the predetermined fuel to air equivalence ratio is maintained. As discussed above the predetermined equivalence ratio may correspond to 6PHI. In certain scenarios, to maintain the fuel to air equivalence ratio compressed air may be provided in the second combustor portion 138 along with the fuel and the exhaust gases.

In the second combustor portion 138, the mixture of the fuel and the air, and the one or more first free radicals are heated at a second temperature in the second predetermined temperature range. In an embodiment, the heat from the exhaust gases is used to heat the mixture of the fuel and the compressed air, and the one or more first free radicals. In an embodiment, the amount of exhaust gases, in the second combustor portion 138, is controlled in such a manner that the second combustor portion 138 is maintained at the second temperature. In addition to the heat from the exhaust gases, the heat from the aforementioned chemical equations is also utilized to heat the mixture of the fuel and the compressed air, and the one or more first free radicals. In an embodiment, the second temperature may be in a range from 750K to 950K. In an embodiment, at the second temperature, the fuel and the one or more first radicals are further partially oxidized to generate one or more second free radicals. In an embodiment, the following chemical reaction process is facilitated by the second combustor portion 138 to generate the one or more second free radicals:

CH₃,CH₃O₂ [symbol] OH

HO₂,H₂O₂ [symbol] OH

CH₄+O₂=CH₃+HO₂

CH₃+O₂═CH₃O₂

CH₃O₂+CH₃=CH₃O+CH₃O

CH₃O+M=H+CH₂O+M

H+O₂+M=HO₂+M

CH₄+HO₂=CH₃+H₂O₂

H₂O₂+M=OH+OH+M

In an embodiment, the hydroxyl radicals (OH) correspond to the one or more second radicals. In an embodiment, the one or more second free radicals correspond to the reformed fuel that is supplied to the engine 102 for combustion process. A person having ordinary skills in the art would appreciate that the scope of the disclosure is not limited to hydroxyl radicals (OH) as the one or more second radicals. In an embodiment, the composition of the one or more second radicals is dependent on the predetermined ratio of the exhaust gases, the compressed air, and the fuel in the first combustor portion 136 and the second combustor portion 138. For instance, if the CH₄ is inputted to the fuel reformer 114 at a fuel to air equivalence ratio of 6PHI, the one or more second free radicals include H₂ and CO. In an embodiment, the one or more second free radicals may further include, but are not limited to, H₂, H₂O₂, OH, CH₄, CH₃O₂, or any other by product obtained after partial oxidation of the fuel. Further, a person having ordinary skills in the art would appreciate that the one or more second free radicals may correspond to an increased concentration of the one or more first free radicals.

As the fuel reformation in the second combustor portion 138 is performed in absence of the catalyst, therefore the second combustor portion 138 corresponds to a non-catalytic combustor.

Similar to the first combustor portion 136, the mixture of the fuel and the compressed air, and the one or more first free radicals reside in the second combustor portion 138 for a second predetermined time period. In an embodiment, the second predetermined time period may correspond to a time period in which the mixture of the fuel and the compressed air, and the one or more first free radicals are heated and accordingly are partially oxidized to form the one or more second free radicals. In an embodiment, the second predetermined time period may be 0.05 seconds.

A person having ordinary skills in the art would appreciate that the scope of the disclosure is not limited to the fuel reformer 114 having two combustor portion. In an embodiment, the fuel reformer 114 may include only the second combustor portion 138. In such a scenario, the second combustor portion 138 is maintained at the second temperature in the second predetermined range. As discussed above the second predetermined range is from 750K to 950K. Further, in such a scenario, the second combustor portion 138 may not receive the one or more first free radicals. In an embodiment, the second combustor portion 138 may directly receive the fuel from the fuel tank 112, the compressed gas from the compressor 116 and the exhaust gases from the engine 102. In an embodiment, the mixture of the fuel and the compressed air is heated to the second temperature directly to partially oxidize the fuel in order to generate the one or more second radicals.

### INDUSTRIAL APPLICABILITY

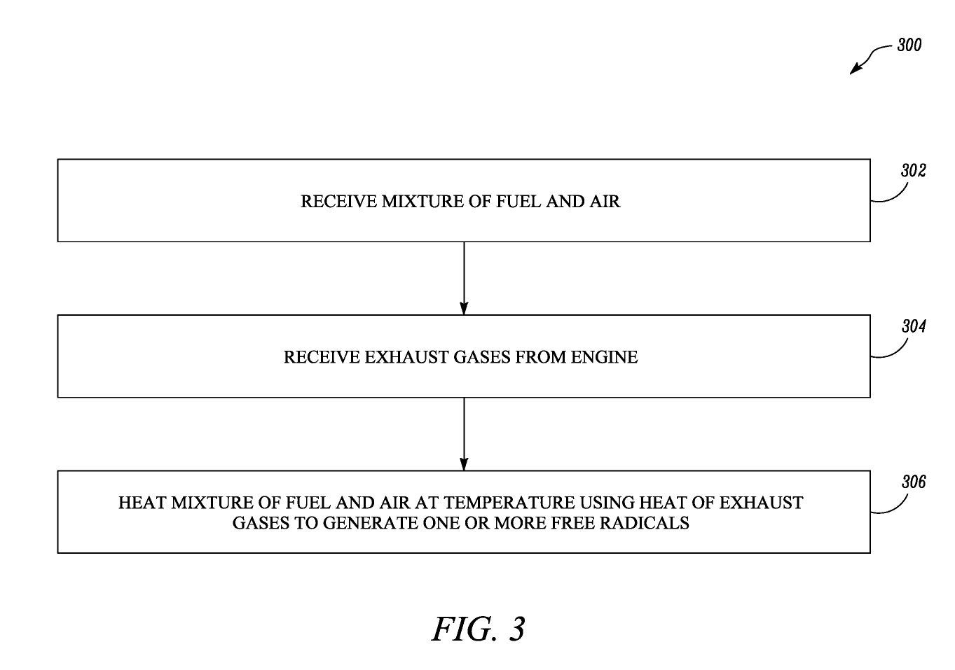

Referring to FIG. 3, a flowchart 300 of a method for reforming the fuel is provided. The flowchart 300 has been described on conjunction with FIG. 1 and FIG. 2. The method is performed at the fuel reformer 114.

At step 302, the fuel and the compressed air is received from the compressor 116 and the fuel tank 112, respectively. In an embodiment, the fuel reformer 114 receives the fuel and the compressed air. At step 304, the exhaust gases are received from the engine 102. In an embodiment, the fuel reformer 114 receives the exhaust gases. In an embodiment, the exhaust gases are mixed with the mixture of the fuel and the compressed air.

At step 306, the mixture of the fuel and the compressed air is heated at the predetermined temperature in a range from 550K to 950K. In an embodiment, in the fuel reformer 114, the heat from the exhaust gases are used to heat the mixture of the fuel and the compressed air, in absence of catalyst, for the predetermined time period. This causes partial oxidation of the fuel to generate the one or more free radicals. Further, the one or more free radicals correspond to the reformed fuel that is supplied to the engine 102 for combustion purposes.

As the reformed fuel is generated without a catalyst, the cost of reforming the fuel is reduced. Further, as the heat produced during the operation of the engine 102 is utilized to reform the fuel, no external heat source is required.

The reformed fuel includes one or more free radicals that are highly reactive in comparison to the unreformed fuel. Therefore, in lean conditions or in high EGR conditions, the reformed fuel ignites readily to provide proper combustion and thus engine misfire is avoided. Also, proper flame propagation is achieved in the engine cylinder.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for reforming fuel for an engine, the method comprising:
heating, in a non-catalytic combustor, a mixture of fuel and air at a temperature in a range from 550K to 950K, to partially oxidize the fuel to generate one or more free radicals, wherein the one or more free radicals constitute reformed fuel, wherein the reformed fuel is supplied to the engine.

2. The method of claim 1 further comprising receiving exhaust gases from the engine, wherein the exhaust gases are utilized to heat the mixture of the fuel and the air.

3. The method of claim 2, wherein the exhaust gases are mixed with the mixture of the fuel and the air.

4. The method of claim 1, wherein the mixture of the fuel and the air is heated using the heat transferred from the engine through a heat exchanger.

5. The method of claim 1, wherein the non-catalytic combustor corresponds to a fuel reformer having a first combustor portion and a second combustor portion.

6. The method of claim 5 further comprising facilitating flow of the mixture of the fuel and the air through the first combustor portion and the second combustor portion, wherein the mixture of the fuel and the air is heated in the first combustor portion and the second combustor portion.

7. The method of claim 5, wherein the mixture of the fuel and the air resides in the first combustor portion for a first predetermined time period, and wherein the mixture of the fuel and the air resides in the second combustor portion for a second predetermined time period.

8. The method of claim 7, wherein a sum of the first predetermined time period and the second predetermined time period corresponds to a predetermined time period, wherein the mixture of the fuel and the air is heated in the non-catalytic combustor for the predetermined time period.

9. The method of claim 5, wherein the partial oxidation of the fuel in the first combustor portion generates one or more first free radicals.

10. The method of claim 9 further comprising receiving, by the second combustor portion, the mixture of the fuel and the air, and the one or more first free radicals from the first combustor portion.

11. The method of claim 10, wherein the partial oxidation of the fuel in the second combustor portion generates one or more second free radicals, wherein the one or more second free radicals correspond to the one or more free radicals.

12. The method of claim 10, wherein the partial oxidation of the fuel in the first combustor portion generates heat that is utilizable to heat the mixture of the fuel and the air, and the one or more first free radicals in the second combustor portion.

13. The method of claim 10, further comprising receiving, by the second combustor portion, exhaust gases utilizable to heat the mixture of the fuel and the air, and the one or more first free radicals in the second combustor portion.

14. An engine system comprising:
an engine; and
a fuel reformer fluidly coupled to the engine to supply reformed fuel to the engine, the fuel reformer comprising:
a first combustor portion configured to receive a mixture of fuel and air, wherein the first combustor portion heats the mixture of the fuel and the air at a first temperature for a first predetermined time period to partially oxidize the fuel to generate one or more first free radicals, wherein the first temperature lies in a range from 550K to 750K and
a second combustor portion configured to receive the one or more first free radicals, and the mixture of fuel and the air, wherein the second chamber heats the mixture of the fuel and the air, and the one or more first free radicals at a second temperature for a second predetermined time period to transform the one or more first free radicals to one or more second radicals, wherein the one or more second radicals constitute the reformed fuel to be supplied to the engine, wherein the second temperature lies in a range from 750K to 950K, and
wherein each of the first combustor portion and the second combustor portion correspond to a non-catalytic combustor.

15. The engine system of claim 14 further comprising a compressor configured to compress the air, and supply the compressed air to the fuel reformer.

16. The engine system of claim 14, wherein the first combustor portion and the second combustor portion are configured to receive exhaust gases from the engine.

17. The engine system of claim 14, wherein the exhaust gases are configured to heat the first combustor portion and the second combustor portion to the first temperature and the second temperature, respectively.
